(19) United States
(12) Patent Application Publication
(10) Pub. No.: US 2023/0151896 A1
(43) Pub. Date: May 18, 2023

(54) VALVE ASSEMBLY, IN PARTICULAR FOR MOTORIZED VEHICLES, WITH ROTATABLE VALVE BODY WITH IMPROVED IMPERMEABILITY

(71) Applicant: Röchling Automotive SE & Co. KG, Mannheim (DE)

(72) Inventors: Davide Monsorno, Trento (TN) (IT); Fabrizio Chini, Isera (TN) (IT); Guenter Holzner, Terlano (IT); Matteo Zanin, Laives (BZ) (IT); Laura Fismaister, Bolzano (BZ) (IT); Marco Barbolini, Bolzano (BZ) (IT)

(21) Appl. No.: 17/983,506

(22) Filed: Nov. 9, 2022

(30) Foreign Application Priority Data
Nov. 18, 2021 (DE) 10 2021 130 162.9

(51) Int. Cl. F16K 11/083; F16K 3/26

(52) U.S. Cl. CPC F16K 11/083; F16K 3/26

(57) ABSTRACT

A valve assembly for influencing operating fluid flows in a motorized vehicle, where the valve assembly includes:
A valve housing with a main housing body and a housing lid,
A fluid line arrangement with at least two fluid lines,
A valve body configured as tapering along an actuating axis which is accommodated rotatably about the actuating axis between at least two fluid lines of the fluid line arrangement in such a way that through rotation of the valve body about the actuating axis, a flow-connection state of the at least two fluid lines proceeding in different spatial regions with each other is modifiable, and
A pre-tensioning means arranged between the housing lid and the valve body which loads the valve body along the actuating axis,
   wherein it is provided that between the valve body and the main housing body there is arranged a guide shell surrounding the valve body, where the valve body is loaded through the pre-tensioning means towards the guide shell along a first pre-tensioning force path, where the guide shell is loaded through the housing lid towards the main housing body along a second pre-tensioning force path.

This application claims priority in German Patent Application DE 10 2021 130 162.9 filed on Nov. 18, 2021 which is incorporated by reference herein.

The present invention concerns a valve assembly which is suitable for influencing operating fluid flows, in particular cooling fluid flows, especially preferably cooling liquid flows, in a motorized vehicle. The valve assembly comprises:
A valve housing with a main housing body and a housing lid connected with the main housing body, where in the valve housing there is configured a valve body accommodating space which is enclosed by the main housing body and the housing lid,
A fluid line arrangement with at least two fluid lines, which starting from the valve body accommodating space proceed in different spatial regions,
A valve body configured as tapering along an actuating axis, which is accommodated rotatably about the actuating axis in the valve body accommodating space between at least two fluid lines of the fluid line arrangement proceeding in different spatial regions in such a way that through rotation of the valve body about the actuating axis a flow-connection state of the at least two fluid lines of the fluid line arrangement proceeding in different spatial regions with each other is modifiable, and
A pre-tensioning means which loads the valve body along the actuating axis in the tapering direction, where the pre-tensioning means is arranged between the housing lid and the valve body.

### BACKGROUND OF THE INVENTION

Such a valve assembly is known from WO 2017/220350 A1. The valve assembly known from WO 2017/220350 A1 serves for the quantitative control of liquid flows in a liquid circuit of a motorized vehicle air-conditioning system. ‘Quantitative control’ within the meaning of the present application also comprises the binary switching-over between permitting a flow and blocking a flow. A further valve assembly similar in its structural layout is known from EP 3 657 055 A1.

The valve assembly known from WO 2017/220350 A1 exhibits a conical valve body which is accommodated in a negative-conical valve body accommodating space. Through the loading of the valve body along its conical axis into the valve body accommodating space, a secure abutment of the valve body against a boundary wall of the valve body accommodating space can be ensured regardless of changes in the dimensions of the valve body and of the main housing body during the operation of the valve assembly, such as for instance due to thermal longitudinal change or wear.

The impermeability of the gap between the valve body and the wall surface of the valve body accommodating space lying opposite to it can be adjusted inter alia through the axial pre-tensioning along the actuating axis provided by the pre-tensioning means. In rough terms it is the case that the more strongly the valve body is pressed against an abutment surface lying opposite to it, the greater the impermeability. The manner of the tapering of the valve body and of the valve body accommodating space too, in particular the inclination angle of the outer surface of the valve body and of the abutment surface lying opposite to it towards the actuating axis, play a part in the implementation of the axial loading of the valve body through the pre-tensioning means and of the abutment force of the valve body against an abutment surface lying opposite to it resulting from same.

However, the actuating force needed for actuating the valve body increases with the axial loading of the valve body through the pre-tensioning means.

### SUMMARY OF THE INVENTION

It is the task of the present invention to develop the valve assembly mentioned at the beginning in such a way that it can be operated with a relatively moderate actuating force with at the same time high impermeability.

The present invention solves this task in a valve assembly of the type mentioned at the beginning by having a guide shell which surrounds the valve body arranged between the valve body and the main housing body, where the valve body is loaded by the pre-tensioning means towards the guide shell along a first pre-tensioning force path. The guide shell is pressure-loaded by the housing lid along a second pre-tensioning force path different from the first pre-tensioning force path. This allows the application of respectively suitable, quantitatively differing loading effects onto the valve body on the one hand and onto the guide shell on the other.

The solution of the present task, starting from the state of the art cited above, is comparatively complex. The central object of the solution according to the invention is the guide shell, configured separately from the main housing body, which is arranged between the valve body and the main housing body. This guide shell can be made from a material which provides high shape retention of the guide shell made from it and/or high wear resistance and/or a low coefficient of friction with the valve body. Due to the low coefficient of friction, the actuating force required during actuation can be reduced for a given loading by the pre-tensioning means.

Through the use of the guide shell it is sufficient to design the latter with high precision, i.e. with small shape and dimensional tolerances.

The main housing body can be fabricated from a material which offers especially high strength, in particular tensile and bending strength, such that the valve housing can withstand high mechanical loads. Therefore the material of the main housing body has a quantitatively comparatively high modulus of elasticity. Since the guide shell in which the valve body is axially immersed is designed with high precision, the main housing body can be made with low accuracy and consequently with large shape and dimensional tolerances.

The actuating axis defines in the present application a cylindrical coordinate system with an axial direction proceeding along the actuating axis, radial directions proceeding orthogonally to the actuating axis, and a circumferential direction proceeding around the actuating axis. Unless stated expressly otherwise, in the present application this coordinate system is used to describe the present invention.

In order, on the one hand, to be able to load the guide shell towards the main housing body with a force which is independent of the valve body or at least with one which differs from the axial pre-tensioning by the pre-tensioning means, and in order, on the other hand, to be able to pre-tension the valve body towards the guide shell with a loading force appropriate for it regardless of the axial loading of the guide shell, there are two different pre-tensioning force paths configured at the valve assembly. Consequently, the valve body can for example be pressure-loaded with a first axial force along the actuating axis under mediation of the pre-tensioning means and the guide shell can be loaded with a second axial force different from the first one along the actuating axis in the direction towards the main housing body. Preferably, the first axial force is quantitatively smaller than the second axial force in order not to make actuation of the valve body unnecessarily difficult.

For the sake of simplified assembly, the housing lid is preferably the starting point both of the first and of the second pre-tensioning force path, such that with the arrangement of the housing lid at the main housing body both the guide shell and the valve body can be loaded under mediation of the pre-tensioning means along the actuating axis with preferably different axial loading forces.

Thereby there results very good impermeability of the valve assembly overall with relatively small actuation forces being required for actuating the valve body and with large fabrication tolerances as regards the main housing body. With apart from that specified shape and specified material, the actuation forces are determined essentially by the first pre-tensioning force path according to height. In the first pre-tensioning force path, with a given construction as to the shape and material of the housing lid and valve body, the design and arrangement of the pre-tensioning means are decisive for the axial loading of the valve body. For the best possible separation of the two pre-tensioning force paths, the first pre-tensioning force path acts in a first region of the housing lid together with the housing lid and/or takes its starting point in a first region of the housing lid respectively and the second pre-tensioning force path acts in a second region of the housing lid different from the first region of the housing lid together with the housing lid and/or takes its starting point in a second region of the housing lid different from the first region of the housing lid respectively.

In order to fulfil their different functions and for production with different fabrication tolerances, the guide shell and the main housing body can be formed from different materials. Preferably the guide shell, which due to its higher shape and dimensional accuracy is more expensive to fabricate, is smaller than the main housing body.

The guide shell is preferably an injection-molded component and to ensure high shape accuracy and high material strength can be formed for example from a thermoplastic synthetic filled with glass fibers and/or with glass particles. The thermoplastic synthetic can for example be formed from a polyphthalamide (PPA) or from polyphenylene sulfide (PPS) or comprise such a synthetic. Naturally the guide shell can also be formed from another thermoplastic synthetic or from metal, in particular from stainless steel, but the aforementioned thermoplastic materials, in particular as filled thermoplastics, are preferable.

The valve body is preferably likewise formed at least in part or preferably completely from a thermoplastic synthetic filled with glass fibers and/or with glass particles, in particular from PPA or from PPS. In order to facilitate the disposal of the valve assembly, preferably the valve body is formed from the same material as the guide shell in order to keep the number of different synthetics in the valve assembly small.

In principle, the valve body can be configured as tapering along the actuating axis in an arbitrary manner. For automated readjustment in case of wear or thermal dimensional change, the valve body preferably tapers conically and/or exhibits a conical envelope, as the case may be.

For actuating the valve body about the actuating axis, i.e. for changing its relative rotational position relative to the valve housing, there can project from the valve body an actuating shaft along the actuating axis. This actuating shaft can penetrate through the valve housing in order to connect a rotary drive, preferably arranged outside the valve housing, with the valve body. Through the preferable injection-molded configuration of the valve body, the valve body can be preferably configured integrally with the actuating shaft to further reduce the number of components of the valve arrangement. Then an actuating stub shaft configured integrally with the valve body can project from the valve body along the actuating axis.

The main housing body can in whole or in part, for instance when it is made of several parts, be made from polypropylene, polyamide, polybutylene terephthalate (PBT), polyethylene terephthalate (PET), and the like. The main housing body can be made in whole or in part from a synthetic filled with glass fibers and/or with glass particles in order to increase its strength. The housing lid too, can be made from the aforementioned materials, again filled or unfilled. The housing lid is preferably made from the same material as the main housing body in order to achieve the best possible material compatibility between the housing lid and the main housing body.

Preferably the main housing body and/or the housing lid is and/or are respectively implemented as an injection-molded component.

The guide shell surrounds the valve body along a common axially extending section preferably completely in the circumferential direction and exhibits an inner surface which tapers, in particular tapers conically, along the actuating axis, preferably in a complementary manner to the valve body. In order to be able to effect as simply as possible a uniform axial loading of components or component sections surrounding and supporting the guide shell radially outside, the guide shell also exhibits an outer surface which tapers, in particular tapers conically, along the actuating axis. Preferably the wall thickness of the guide shell is constant between the inner and outer surface along the actuating axis. The guide shell can as a classical jar exhibit at its tapered, smaller-diameter end a bottom, however this does not have to be the case. The guide shell can be configured as a sleeve open at both axial longitudinal ends extending along the actuating axis, which due to the tapering of the guide shell along the actuating axis exhibits at the two opposite axial longitudinal ends different aperture dimensions.

The guide shell exhibits passages for the fluid lines realized at the valve arrangement, which for controlling their fluid flows by the valve body should reach the valve body.

Any impermeability problems between the guide shell and the main housing body arising from the arrangement of the guide shell in the main housing body can be mitigated or even cleared up by arranging a shell gasket between the guide shell and the main housing body. The shell gasket can be designed and arranged as a separate sealing component. In order to facilitate assembly, however, the shell gasket can also be injected outside onto the guide shell, for instance by means of a multi-component, for instance a 2-component injection-molding process.

In order to be able to pre-tension the shell gasket through pressure loading in such a way that it acts optimally as a seal and in order furthermore to be able to pre-tension the valve body with a loading force appropriate to it towards the guide shell independently of the pressure loading of the shell gasket, the valve body can be pressure-loaded along the actuating axis with the first axial force through the pre-tensioning means or rather preferably through the housing lid under mediation of the pre-tensioning means and the shell gasket can be loaded along the actuating axis, preferably through the housing lid, under mediation of the guide shell with a third axial force different from the first. Preferably, the first axial force is quantitatively smaller than the third axial force, in order not to make actuation of the valve body unnecessarily difficult.

In an ideal, loss-free system the third axial force equals the second axial force, since the guide shell merely transmits the axial force exerted on it to the shell gasket. Through deformation and/or internal damping of the guide shell, however, the second and the third axial force can differ quantitatively.

For the transmission of compressive force from the housing lid to the guide shell, and where applicable further under mediation of the guide shell to the shell gasket, the guide shell can be physically supported at the housing lid directly or indirectly under interposition of an intermediate component. In order to separate the pre-tensioning force paths, the intermediate component is not the pre-tensioning means of the valve body.

The supporting of the guide shell at the housing lid can be realized by having the guide shell in direct or indirect abutting engagement with the housing lid. The housing lid fitted to the main housing body can then be readily lifted off or removed as the case may be from the guide shell with a termination of the abutting engagement. In this case, only a compressive force can be transmitted from the housing lid to the guide shell. In order to realize a pressure loading of the shell gasket there suffices a force transmission from the main housing body to the guide shell in exactly one direction. This is preferably the axial direction defined by the actuating axis away from the housing lid into the valve body accommodating space. In order to avoid an undesirable installation gap, preferably the guide shell is directly in abutting engagement with the housing lid.

Alternatively it can be provided that the guide shell is directly or indirectly in positive-locking engagement with the housing lid. Once again, direct positive-locking engagement between the housing lid and the guide shell is preferable in order to avoid installation gaps. In this way, the housing lid and the guide shell can be preassembled as a module and inserted as a preassembled module at the main housing body.

Preferably the position, especially preferably only the position, of the housing lid relative to the main housing body with an otherwise predefined shape and predefined material of housing lid, guide shell, and shell gasket determines the pressure loading of the shell gasket through the guide shell. The pressure loading of the shell gasket can thereby be adjusted structurally by connecting the housing lid with the main housing body. With a preferable fusing or welding respectively of the housing lid with the main housing body, the relative position of the housing lid relative to the main housing body and thus the pressure loading of the shell gasket can be selectively chosen, adjusted, and fixed by adjusting the welding parameters, such as welding temperature, welding duration, and joining pressure.

Additionally or alternatively, it can be provided that the position, especially preferably only the position, of the housing lid relative to the main housing body with an otherwise predefined shape and predefined material of housing lid, pre-tensioning means, and valve body determines the loading of the valve body through the pre-tensioning means towards the guide shell. The pre-tensioning means is preferably configured as a spring component, especially preferably with spring characteristics which obey Hooke's law, such as for example a coil spring or a disk spring, in particular a disk spring assembly. As a spring, the pre-tensioning means is preferably made from metal, especially preferably from stainless steel, in order to maintain its spring properties permanently. The pre-tensioning means can in particular be the only metal component out of housing lid, main housing body, valve body, pre-tensioning means, guide shell, shell gasket, and if applicable intermediate component.

In principle it can be provided to have the housing lid bolted or riveted to the main housing body. In order to produce an especially tight valve housing, however, it is preferable if the housing lid is firmly bonded, in particular fused, especially preferably welded with the main housing body. As already described above, the relative position, in particular the relative axial position, of the housing lid to the main housing body and thereby the loading of the valve body towards the guide shell along the first pre-tensioning force path and the pressure loading of the guide shell and where applicable also of the shell gasket along the second pre-tensioning force path can be adjusted and permanently fixed through the choice of the join parameters during fusing or welding, as the case may be.

Alternatively it can be provided to join the housing lid with the main housing body by positive locking, in particular with a catch or snap-fit. Indeed, the interposition of a seal between the housing lid and the main housing body may then be necessary, but the risk of thermal deformation of the valve housing which is present when carrying out a thermal assembly process does not apply. When the region between the main housing body and the guide shell on the one hand and between the guide shell and the valve body on the other is well sealed, which is possible precisely with the arrangement recommended here, an arrangement of a seal between the housing lid and the main housing body can be dispensed with even with a not firmly bonded joining of these components.

Ro prevent abrasion through the pre-tensioning means at the housing lid and/or at the valve body, a bearing component can be arranged in the first pre-tensioning force path between the housing lid and the pre-tensioning means and/or between the pre-tensioning means and the valve body. The bearing component can for example be formed from an elastomer, such as for example natural or synthetic rubber. As preferred materials, EPDM, i.e. ethylene propylene diene rubbers or more specifically ethylene propylene diene (monomer) rubbers, or fluoroelastomers, as for instance FKM as designed according to DIN ISO 1629 or according to ASTM D 1418 as the case may be, can be used. The bearing component can consequently be made at least section-wise or completely from an elastomer.

The shell gasket is preferably made at least in part or completely from an elastomer, such as for instance natural or synthetic rubber. The material for the shell gasket can also preferably be chosen out of EPDM and FKM.

The shell gasket, like the guide shell, is arranged at the valve assembly unmovably relative to the main housing body. In principle it could suffice if the shell gasket surrounds only the fluid lines of the fluid line arrangement. Therefore a shell gasket can be arranged only locally in the region of a passage of a fluid line through the guide shell on the outside of the guide shell between the guide shell and the valve housing, in particular the main housing body, whereas in the rest of the region of the guide shell no shell gasket is arranged. Since the valve body, depending on its operational position about the actuating axis, normally connects with one another or separates from one another at least two fluid lines, the shell gasket can be formed out of several shell part-gaskets. Preferably, however, the shell gasket is a single sealing component which surrounds the guide shell radially outside. In particular when the guide shell exhibits a bottom, the shell gasket can also exhibit a bottom, which on the outside of the bottom of the guide shell abuts against the latter or at least faces the latter. The shell gasket therefore preferably proceeds like the guide shell, except for the passages of the fluid lines, in a closed manner about the actuating axis.

The shell gasket preferably exhibits in the relaxed and/or in the pressure-loaded state an inner surface tapering, in particular conically tapering, along the actuating axis. The shell gasket preferably exhibits in the relaxed and/or in the pressure-loaded state an outer surface tapering, in particular conically tapering along the actuating axis. Preferably the wall thickness of the shell gasket in the relaxed and/or in the pressure-loaded state is essentially constant at least along the tapering sections of the inner and outer surface.

The shell gasket exhibits passages for the fluid lines realized at the valve arrangement, so that the fluid flows can reach the valve body.

In principle the valve body can directly contact the inner surface of the guide shell and seal against it. Due to the preferable choice of a high-strength, normally filled, synthetic for fabricating the guide shell, however, a relative movement of the valve body and the guide shell can present undesirable side-effects, such as for example increased wear through abrasion. Therefore, between the valve body and the guide shell there can be arranged an abutment component immovably relative to the guide shell. The abutment component can abut against the inner surface of the guide shell and the valve body can in turn abut against the abutment component, in particular against an inner surface of the latter. The abutment component too, therefore, preferably exhibits an inner surface tapering, in particular conically, along the actuating axis and an outer surface tapering, in particular conically, along the actuating axis. Preferably the material thickness or more specifically the wall thickness of the abutment component is constant along the actuating axis.

The abutment component can be formed from a synthetic which is low friction in a tribological pairing with the valve body, for example from polytetrafluoroethylene (PTFE), from PTFE blends, such as for example a blend of polybutylene terephthalate and PTFE, a blend of a polyoxymethylene and PTFE, or from a polyoxymethylene, from ethylene-tetrafluoroethylene copolymer, from polyphthalamide, or from polyvinylidene fluoride. The abutment component too, is preferably an injection-molded component.

In order to achieve the best possible impermeability, preferably at least one section of the main housing body which encloses the valve body accommodating space is configured in one piece.

Alternatively, in order to also realize complex shapes of the main housing body, where applicable with fluid line sections of the fluid line arrangement, a section of the main housing body which encloses the valve body accommodating space can be configured in several parts. For example, the section of the main housing body which encloses the valve body accommodating space can be configured in at least two parts, preferably in exactly two parts.

In order to reduce the number of components which are needed to form the valve assembly and its functional setting, in an advantageous development of the invention the main housing body can be formed from a section of a duct component in which fluid lines of the fluid line arrangement are configured. The main housing body is preferably configured integrally with the duct component.

The duct component can comprise an upper shell and a lower shell, each of which is preferably injection-molded and which together form the hollow duct component with at least one section of the fluid line arrangement, preferably with the entire fluid line arrangement. In a preferred embodiment, the section of the main housing body which encloses the valve body accommodating space can exhibit the upper shell of the duct component and the lower shell of the duct component which is connected with the upper shell, where the housing lid is connected with the upper shell. Complex physical designs of the main housing body and sections of fluid lines attached to it can hereby be realized through injection molding. The main housing body can also be formed only by the lower shell of the duct component.

The fluid lines configured in the duct component are preferably longer than the flow path through the valve body accommodating space, especially preferably at least twice as long, more especially preferably at least three times as long, in order to be able to provide the valve assembly together with the fluid lines influenced by it in a controlling manner as a preassembled module.

Preferably each of the aforementioned components of the valve assembly, with the exception of the pre-tensioning means, is configured as an injection-molded component. The pre-tensioning means too, however, can be an elastomeric spring.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWINGS

The invention may take physical form in certain parts and arrangement of parts, a preferred embodiment of which will be described in detail and illustrated in the accompanying drawing which forms a part hereof and wherein:

FIG. 1A rough schematic longitudinal section view through an embodiment according to the invention of a valve assembly in a sectional plane which contains the actuating axis.

### DESCRIPTION OF PREFERRED EMBODIMENTS

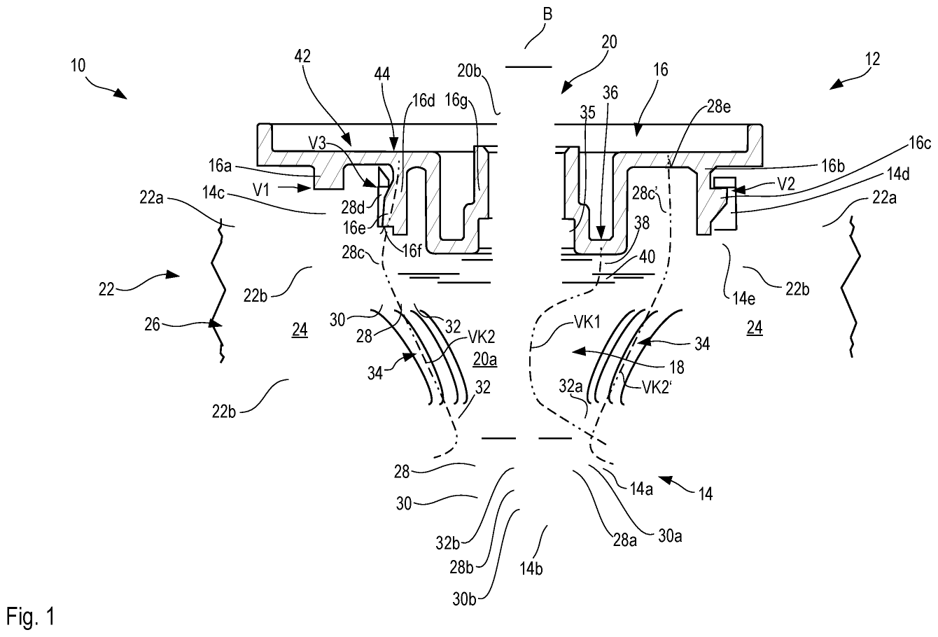

Referring now to the drawing wherein the showings are for the purpose of illustrating preferred and alternative embodiments of the invention only and not for the purpose of limiting the same, in FIG. 1, an embodiment according to the invention of the valve assembly of the present application is depicted in rough schematic form and labelled generally by 10. The valve assembly 10 comprises a valve housing 12 with a main housing body 14 and a housing lid 16. The main housing body 14 and the housing lid 16 bound a valve body accommodating space 18, in which a valve body 20 is accommodated rotatably about an actuating axis B.

The main housing body 14 is configured in the depicted embodiment example integrally with a duct component 22, in which there are configured fluid lines 24 of a fluid line arrangement 26 which lead to the valve body accommodating space 18 and away from the latter. More precisely, the duct component 22 is formed from an upper shell 22a and a lower shell 22b, which preferably are each injection-molded and which are firmly bonded with each other through a synthetic material welding method. The fluid lines 24 configured in the duct component 22 are configured as longer, preferably by at least twice, especially preferably by at least three times, longer than the flow path through the valve body accommodating space 18.

The main housing body 14, which in the depicted embodiment example is formed solely by the lower shell 22b, exhibits a conical section 14a which tapers in the direction away from the housing lid 16. The main housing body 14 exhibits besides a bottom section 14b which closes up the valve body accommodating space 18 on the side axially opposite to the housing lid 16 axial.

Between the valve body 20 and the main housing body 14 there is arranged a guide shell 28, such that the valve body 20 does not come directly in contact with the main housing body 14. The guide shell 28 is likewise injection-molded and is made with high precision, i.e. with small fabrication tolerances. The use of such a guide shell 28 with small shape and dimensional tolerances allows the rest of the valve housing 12 to be formed by means of injection molding with large fabrication tolerances and thereby cost-effectively.

The guide shell 28, which in order to achieve high component strength is preferably made from a filled thermoplastic synthetic, is accommodated in the valve body accommodating space 18 immovably relative to the main housing body 14. This means that the valve body 20 rotates about the actuating axis B not only relative to the main housing body 14 but also relative to the guide shell 28. The guide shell 28 can be accommodated in the main housing body 14 immovably, in particular in a non-twistable manner, relative to the latter by means of frictional engagement and/or positive locking and/or through an adhesive agent.

In order to fill and/or seal as the case may be the gap arising in many cases between the guide shell 28 with small shape and dimensional tolerances and the main housing body 14 and/or the lower shell 22b respectively with large fabrication tolerances, there is arranged between the guide shell 28 and the main housing body 14 a shell gasket 30. The shell gasket 30 is arranged immovably relative to the guide shell 28 and thereby also relative to the main housing body 14. The shell gasket 30 is deformable only between the guide shell 28 and the main housing body 14 in order to ensure its sealing effect.

The shell gasket 30 can be provided as a component separate from the guide shell 28 or as a component injected outside onto the guide shell 28.

In order, furthermore, to reduce the friction between the valve body 20 and the guide shell 28 and to seal gaps that may potentially exist there, between the valve body 20 and the guide shell 28 there is arranged an abutment component 32. The abutment component 32, which preferably is arranged as a separate component, is likewise arranged at the guide shell 28 immovably relative to the guide shell 28, in particular in a non-twistable manner about the actuating axis B. The abutment component 32 can be arranged at the guide shell 28 immovably, in particular in a non-twistable manner, relative to the latter by means of adhesive agents, frictional engagement, or positive locking.

Like the main housing body 14, the guide shell 28, the shell gasket 30, and the abutment component 32 too not only taper conically away from the housing lid 16, but also are configured as jar-shaped with a bottom 28b, 30b, and 32b respectively parallel to the bottom section 14b of the main housing body 14. The individual bottoms 28b, 30b, and 32b respectively can be arranged at a distance from one another or can touch one another, as for example the bottom 30b touches the bottom 14b in FIG. 1. Neighboring conical sections 28a, 30a, and 32a respectively abut against one another. Furthermore, the conical section 30a of the shell gasket 30 also abuts against the inner surface of the conical section 14a of the main housing body 14. Hereby there is achieved impermeability of the valve assembly 10 around the apertures 34 through which the fluid lines 24 are connected with the valve body accommodating space 18.

The abutment component 32 is formed, in order to reduce the friction effect with the valve body 20 abutting against it, from a low-friction material such as for example PTFE. Other materials, as quoted in the descriptive introduction, are likewise possible for forming the abutment component 32.

With the exception of the apertures 34, the guide shell 28, the shell gasket 30, and the abutment component 32 proceed in a circumferential direction in a closed manner about the actuating axis B.

In the depicted example, the valve body 20 is injection-molded from PPS filled with glass particles. Instead of the glass particles, glass fibers can also be used as filling material. Instead of the PPS, PPA can also be used as a thermoplastic synthetic. The guide shell 28 is preferably made from the same material as the valve body 20.

In order to achieve the best possible sealing effect, the shell gasket 30 is preferably made from an elastomer, for example from synthetic or natural rubber or from EPDM or FKM.

The valve housing 12, that is, in particular the upper shell 22a and the lower shell 22b of the duct component 22, is made from a low-cost thermoplastic material, for example from a polyolefin, such as for example polypropylene or a polyethylene. The thermoplastic material can, to increase strength, be filled, for example with glass fibers and/or with glass particles or with other reinforcing fibers or particles. The housing lid 16 is preferably made from the same material as the duct component 22, i.e. as the main housing body 14.

The valve body 20 comprises a valve body section 20a with a conical envelope, which is accommodated directly in the valve body accommodating space 18. Integrally with the valve body section 20a there is formed an actuation section 20b projecting from the former along the actuating axis B, which penetrates through the housing lid 16 and thus can be reached from outside for the transmission of torque. A surrounding seal 35 seals the actuation section 20b against a sleeve section 16g of the housing lid 16 which is penetrated through by the actuation section 20b.

The housing lid 16 can be connected in various ways with the duct component 22 and consequently with the main housing body 14. As depicted in FIG. 1 on the left side of the actuating axis B at the connecting point V1, the housing lid 16 can be connected with the main housing body 14 through welding, fusing, or gluing. Since in the present case the main housing body 14 is formed only by the lower shell 22b, the housing lid 16 is also connected only with the lower shell 22b. If the upper shell 22a of the duct component 22 also contributes to forming the main housing body 14, the housing lid 16 can additionally or alternatively be connected with the upper shell 22a, for example through welding, fusing, or gluing. Among the firmly bonded connections, the welded connection and/or the fused connection, as the case may be, is preferred to the glued connection since through the fusing of welded points on the housing lid 16 on the one hand and on the main housing body 14 on the other, the axial position of the main housing body 14 along the actuating axis B relative to the main housing body 14 and/or to the duct component 22 respectively is adjustable for the duration of the later operation.

In order to produce the preferable welded connection, a welding projection 16a on the housing lid can be connected with a welding projection 14c on the main housing body 14, where the welding projections 16a and 14c are preferably fused with each other on the end faces.

Additionally or alternatively, the housing lid 16 can be latched to the main housing body 14, as depicted on the right side of the actuating axis B at the connecting point V2. To this end there can be configured at the housing lid 16 a connecting projection 16b, from which there projects a latching projection 16c. The latching projection 16c can engage in positive locking with a latching recess 14d in a connecting projection 14e of the main housing body 14. In a kinematic reversal of the positively locked latching connection, the connecting projection 14e can also exhibit the latching projection, which engages with a latching recess on the connecting projection 16b of the housing lid 16.

Preferably the projections: welding projections 16a and 14c and the connecting projections 16b and 14e, extend predominantly or completely in the axial direction along the actuating axis B and to a smaller extent or none in the radial direction orthogonally to the actuating axis B. The projections can surround the actuating axis B section-wise or completely.

The latching projection 16c preferably extends predominantly or completely in the radial direction.

The valve body 20 is supported at the housing lid 16 in a first region 36 by a pre-tensioning means 38, for instance a spring component, and pre-tensioned axially in the direction away from the housing lid 16. The pre-tensioning means 38 transmits its force directly to an annular bearing component 40 with a preferably L-shaped cross-section, in particular a bearing component made from a polymer or an elastomer, which abuts against the larger-diameter end face of the valve body section 20a. Through the pre-tensioning force of the pre-tensioning means 38, the valve body section 20a is pre-tensioned towards the abutment component 32 and via the latter towards the guide shell 28, towards the shell gasket 30, and finally towards the main housing body 14, in particular towards its conical section 14a. Consequently there exists a first pre-tensioning force path VK1, from the first region 36 of the housing lid 16 via the valve body 20 up to the conical main housing body 14.

The guide shell 28, and with it the shell gasket 30, can in an especially simple embodiment to be pre-tensioned only via the pre-tensioning means 38 towards the main housing body 14.

The guide shell 28 can be connected, preferably positively-locked connected, with the housing lid 16 in an advantageous manner into a common assembly 42, for instance through a latching connection shown at the connecting point V3. Then the guide shell 28 can advantageously be fitted as an assembly 42 in a single working step together with the housing lid 16.

To this end the housing lid 16 can, as depicted on the left side of the actuating axis B in FIG. 1, exhibit in a second region 44 different from the first region 36 a coupling projection 16d, which interacts in positive locking with a coupling projection 28c of the guide shell 28. In the depicted case, for example, the coupling projection 16d exhibits a latching lug 16e projecting radially from the coupling projection 16d which engages with a latching aperture 28d in the coupling projection 28c of the guide shell 28. The coupling projection 28c preferably proceeds in a closed manner, with the exception of the latching apertures 28d, about the actuating axis B and forms as it were a coupling projection sleeve. The depiction in FIG. 1 notwithstanding, the coupling projection 28c can exhibit the latching lug and the coupling projection 16d the latching aperture.

Especially preferably, the latching lug 16e has an abutment surface 16f, in particular an abutment surface 16f pointing away from the housing lid 16 axially along the actuating axis B, which in the completely assembled state is in abutting engagement with an edge of the latching aperture 28d, thus producing a loading of the guide shell 28 in the direction towards the main housing body 14, and/or in the tapering direction or away from the housing lid 16 respectively, independently from the pre-tensioning means 38.

The second region 44 is situated at a radial distance from the actuating axis B which differs quantitatively from the radial distance of the first region 36 from the actuating axis B. Therefore the first region 36 and the second region 44 differ from one another.

Through the described abutting engagement of the abutment surface 16f of the latching lug 16e of the housing lid 16 with a counter-abutment surface at the guide shell 28, in particular at the edge of the latching aperture 28d, the guide shell 28 can be loaded along a second pre-tensioning force path VK2 starting from the second region 44 of the housing lid 16 towards the main housing body 14, in particular towards its conical section 14a. Through this loading, the shell gasket 30 arranged between the guide shell 28 and the main housing body 14 can be quantitatively so loaded that it deploys its optimal sealing effect.

Additionally or alternatively to the abutting engagement of the latching lug 16e with a counter-abutment surface of the guide shell 28 there can, as depicted in FIG. 1 on the right side of the actuating axis B, a section of the guide shell 28, for example a coupling projection sleeve 28c′ be in simple abutting engagement with a second region 44′ of the housing lid 16, for instance by an end face 28e being in abutting engagement with an inner surface of the housing lid 16. Then an alternative or additional second pre-tensioning force path VK2′ can proceed from the second region 44′ via the guide shell 28 and the shell gasket 30 to the main housing body 14.

Through the provision of first and second pre-tensioning force paths VK1 and VK2 and/or VK2′, the guide shell 28 can be applied with a greater force against the shell gasket 30 and thereby against the main housing body 14 than the force with which the valve body 20 or more precisely the valve body section 20a is pressed against its abutment surface, i.e. in the present case against the abutment component 32. Thereby the force needed to actuate the valve body 20 about the actuating axis B or the torque needed for this purpose, as the case may be, can be adjusted independently of the loading of the guide shell 28 against the main housing body 14. Consequently the valve body 20 can be pre-tensioned with a smaller force against the abutment component 32 and thereby in the direction towards the main housing body 14 than the guide shell 28.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A valve assembly for influencing operating fluid flows, in particular cooling fluid flows, especially preferably cooling liquid flows, in a motorized vehicle, where the valve assembly comprises:
a valve housing with a main housing body and a housing lid connected with the main housing body, where in the valve housing there is configured a valve body accommodating space which is enclosed by the main housing body and the housing lid,
a fluid line arrangement with at least two fluid lines, which starting from the valve body accommodating space proceed in different spatial regions,
a valve body configured as tapering along an actuating axis, which is accommodated rotatably about the actuating axis in the valve body accommodating space between at least two fluid lines of the fluid line arrangement proceeding in different spatial regions in such a way that through rotation of the valve body about the actuating axis a flow-connection state of the at least two fluid lines of the fluid line arrangement proceeding in different spatial regions with each other is modifiable, and
a pre-tensioning means which loads the valve body along the actuating axis in the tapering direction, where the pre-tensioning means is arranged between the housing lid and the valve body arranged is,
wherein between the valve body and the main housing body there is arranged a guide shell which surrounds the valve body, where the valve body is loaded through the pre-tensioning means along a first pre-tensioning force path towards the guide shell, where the guide shell is loaded through the housing lid towards the main housing body along a second pre-tensioning force path different from the first pre-tensioning force path.

17. The valve assembly according to claim 16, wherein the guide shell is supported physically at the housing lid directly or indirectly under interposition of an intermediate component.

18. The valve assembly according to claim 17, wherein the guide shell is directly or indirectly in abutting engagement with the housing lid.

19. The valve assembly according to claim 17, wherein the guide shell is directly or indirectly in positive-locking engagement with the housing lid.

20. The valve assembly according to claim 16, wherein on the side of the guide shell facing away from the valve body there is arranged additionally a shell gasket in order to seal the regions formed by the guide shell of the at least two fluid lines of the fluid line arrangement proceeding in different spatial regions against the main housing body, where the shell gasket is pressure-loaded under force mediation of the guide shell.

21. The valve assembly according to claim 16, wherein the position of the housing lid relative to the main housing body determines the pressure loading of the shell gasket through the guide shell.

22. The valve assembly according to claim 16, wherein the axial position of the housing lid relative to the main housing body determines the pressure loading of the shell gasket through the guide shell.

23. The valve assembly according to claim 16, wherein the position of the housing lid relative to the main housing body determines the loading of the valve body through the pre-tensioning means towards the guide shell.

24. The valve assembly according to claim 16, wherein the axial position of the housing lid relative to the main housing body determines the loading of the valve body through the pre-tensioning means towards the guide shell.

25. The valve assembly according to claim 16, wherein the housing lid is firmly bonded relative to the main housing body.

26. The valve assembly according to claim 16, wherein the housing lid is at least one of fused or welded to the main housing body.

27. The valve assembly according to claim 16, wherein the housing lid is joined with the main housing body by positive locking.

28. The valve assembly according to claim 16, wherein the housing lid is joined with the main housing body with a catch or snap-fit.

29. The valve assembly according to claim 16, wherein in the first pre-tensioning force path between the housing lid and the pre-tensioning means and/or between the pre-tensioning means and the valve body there is arranged a bearing component.

30. The valve assembly according to claim 29, wherein the bearing component is formed at least section-wise or completely from an elastomer.

31. The valve assembly according to claim 16, wherein between the valve body and the guide shell there is arranged an abutment component immovably relative to the guide shell.

32. The valve assembly according to claim 16, wherein at least one section of the main housing body which encloses the valve body accommodating space is configured in one piece.

33. The valve assembly according to claim 16, wherein a section of the main housing body which encloses the valve body accommodating space is configured in at least two parts.

34. The valve assembly according to claim 16, wherein the main housing body is formed from a section of a duct component in which fluid lines of the fluid line arrangement are configured.

35. The valve assembly according to claim 33, wherein the section of the main housing body which encloses the valve body accommodating space exhibits an upper shell and a lower shell connected with the upper shell, where the housing lid is connected with the upper shell and/or with the lower shell.
